(19) United States
(12) Patent Application Publication
(10) Pub. No.: US 2016/0039149 A1
(43) Pub. Date: Feb. 11, 2016

(54) RAPID PROTOTYPE SYSTEM HAVING INTERCHANGEABLE MODULES

(71) Applicant: Leonard J. CASSARA, Boulder, CO (US)

(72) Inventor: Leonard J. CASSARA, Boulder, CO (US)

(21) Appl. No.: 14/782,294

(22) PCT Filed: Apr. 4, 2014
(86) PCT No.: PCT/US2014/032936

§ 371 Date: Oct. 2, 2015

Related U.S. Application Data
(60) Provisional application No. 61/808,417, filed on Apr. 4, 2013.

(51) Int. Cl. B29C 67/00

(52) U.S. Cl. CPC B29C 67/0088; B29C 67/0055; B29C 67/0066; B33Y 30/00

(57) ABSTRACT

A rapid prototype system includes a master unit and a plurality of detachable and interchangeable modules that connect with the master unit physically, electrically, and using software commands. The master includes components that facilitate actions that are performed during many types of rapid prototype methods. For example, the base includes a Z-axis drive mechanism that facilitates raising and/or lowering materials during many types of additive and subtractive rapid prototype methods. Each interchangeable module creates parts or objects according to a rapid prototype method. Some of the interchangeable modules include specialized components (for example, X-axis and Y-axis drive mechanisms) that are unnecessary for some rapid prototype methods.

### CROSS-REFERENCE TO RELATED APPLICATION

This application claims the benefit of U.S. Provisional Patent Application Ser. No. 61/808,417, filed on Apr. 4, 2013, which is incorporated by reference herein in its entirety for all purposes.

### TECHNICAL FIELD

The present invention relates to rapid prototype systems. More specifically, the present invention relates to rapid prototype systems that include a master unit and various interchangeable modules for creating parts or objects according to one of various rapid prototype methods.

### BACKGROUND

Rapid prototype systems typically create objects or components using one of two types of methods: (1) depositing materials to build objects layer-by-layer (that is, an additive method; for example, fused filament fabrication (FFM)); and (2) removing undesired portions from a base material to create objects layer-by-layer (that is, a subtractive method; for example, computer numerically controlled (CNC) carving). Some materials lend themselves to only one type of method. Plastics and polymers typically use additive methods. Wood and foam typically use subtractive methods. Clay and wax may use either additive or subtractive methods.

Rapid prototype systems typically specialize in one type of method (that is, additive or subtractive) using one type of material. Some rapid prototype systems include interchangeable tools to permit the system to perform different types of additive and/or subtractive methods with different materials. However, these systems typically include components that facilitate specialized rapid prototype methods (for example, X-axis and Y-axis drive mechanisms for performing FFM). Such components are not needed for other types of rapid prototype methods (for example, photo-curing polymer projection processes). As such, these systems may be unnecessarily expensive for system users that do not use or infrequently use such specialized rapid prototype methods.

### SUMMARY

In some embodiments, the present invention provides a rapid prototype system that includes a master unit (also referred to as a base but need not be positioned on the bottom of the system) and a plurality of detachable and interchangeable modules (also referred to as lids but need not be positioned on the top of the system) that connect with the base physically, electrically, and using software commands. The base includes components that facilitate actions that are performed during many types of rapid prototype methods. For example, the base includes a Z-axis drive mechanism that facilitates raising and/or lowering materials during many types of additive and subtractive rapid prototype methods. Each interchangeable module creates parts or objects according to, for example, one of the rapid prototype methods described herein. Some of the interchangeable modules include specialized components (for example, an FFM module may include X-axis and Y-axis drive mechanisms) that are unnecessary for some rapid prototype methods (for example, photo-curing polymer projection processes). The master unit is capable of controlling operation of each of the interchangeable modules when connected to the master unit regardless of the specific types of components they include.

In some embodiments, each interchangeable module facilitates performing a rapid prototype method, such as, for example, fused filament fabrication (FFM), sintering, photo-curing polymer, computer numerically controlled (CNC) carving, subsequently developed methods, and the like.

In some embodiments, the base may identify a connected lid in various manners (that is, identify the type of connected lid, determine its components, determine its capabilities, or the like). In some embodiments, the base includes electronic components that determine the type of lid coupled thereto and select a portion of firmware that correctly controls and accurately coordinates actions of the components of the lid.

In some embodiments, a rapid prototype system is configured to manipulate material to form an object. The rapid prototype system includes a master unit having a housing. A first drive mechanism is coupled to the housing, and the first drive mechanism is adapted to displace the material in a first direction. A processor is coupled to the housing, and the processor is operably coupled to the first drive mechanism for controlling the first drive mechanism. The system further includes a plurality of interchangeable modules that are selectively attachable to the master unit. Each of the plurality of interchangeable modules includes at least one component that is operably coupled to the processor of the master unit for controlling the at least one component when the interchangeable module is attached to the master unit. The plurality of interchangeable modules includes a first interchangeable module. The at least one component of the first interchangeable module includes a work tool that is adapted to manipulate the material. A second drive mechanism is coupled to the work tool, and the second drive mechanism drives the work tool in a second direction that is substantially perpendicular to the first direction.

The rapid prototype system of paragraph [0008], wherein the at least one component of the first interchangeable module further includes a third drive mechanism coupled to the work tool, the third drive mechanism driving the work tool in a third direction that is substantially perpendicular to both of the first direction and the second direction.

The rapid prototype system of paragraph [0009], wherein the second drive mechanism includes a first electric motor; a first drive screw driven by the first electric motor, the first drive screw coupled to the work tool to drive the work tool in the second direction; a second electric motor; and a second drive screw driven by the second electric motor, the second drive screw coupled to the work tool to drive the work tool in a third direction that is substantially perpendicular to both the first direction and the second direction.

The rapid prototype system of paragraph [0008], wherein the second drive mechanism includes an electric motor; and a belt driven by the electric motor, the belt coupled to the work tool to drive the work tool in the second direction and a third direction that is substantially perpendicular to both of the first direction and the second direction.

The rapid prototype system of paragraph [0011], wherein the work tool is a filament dispenser being adapted for depositing the material.

The rapid prototype system of paragraph [0008], wherein the plurality of interchangeable modules further includes a second interchangeable module, the at least one component of the second interchangeable module including a light emitting device for emitting light on an object supported by the master unit; and a light receiving device for determining the relative position of the light on the object; wherein the processor is adapted to create a digital three-dimensional image of the object based on the relative position of the light on the object determined by the light receiving device.

The rapid prototype system of paragraph [0013], wherein the first drive mechanism drives the light emitting device and the light receiving device in the first direction.

The rapid prototype system of paragraph [0008], wherein the plurality of interchangeable modules further includes a second interchangeable module, the at least one component of the second interchangeable module including a polymer curing device, the polymer curing device emitting light on the material, and the material being a photo-curing resin.

The rapid prototype system of paragraph [0008], wherein the master unit further includes a platform adapted to support the material, the first drive mechanism driving the platform in the first direction.

The rapid prototype system of paragraph [0008], wherein the master unit further includes an electrical connector coupled to the processor, and the first interchangeable module further includes an electrical component coupled to the at least one component, the electrical component couples to the electrical connector when the first interchangeable module is attached to the master unit, and the electrical component decouples from the electrical connector when the first interchangeable module is detached from the master unit.

In some embodiments, a rapid prototype system is configured to manipulate material to form an object. The rapid prototype system includes a master unit having a housing. A first drive mechanism is coupled to the housing, and the first drive mechanism is adapted to displace the material in a first direction. A processor is coupled to the housing, and the processor is operably coupled to the first drive mechanism for controlling the first drive mechanism. The system further includes a plurality of interchangeable modules that are selectively attachable to the master unit. Each of the plurality of interchangeable modules includes at least one component that is operably coupled to the processor of the master unit for controlling the at least one component when the interchangeable module is attached to the master unit. The plurality of interchangeable modules includes a first interchangeable module. The at least one component of the first interchangeable module includes a first work tool that is adapted to manipulate the material and a second drive mechanism coupled to and driving the first work tool. The plurality of interchangeable modules includes a second interchangeable module. The at least one component of the second interchangeable module includes a second work tool that is adapted to manipulate the material and a third drive mechanism coupled to and driving the second work tool. The third drive mechanism is of a type different than the second drive mechanism.

The rapid prototype system of paragraph [0018], wherein the second drive mechanism includes a first electric motor; a first drive screw driven by the first electric motor, the first drive screw coupled to the first work tool to drive the first work tool in a second direction that is substantially perpendicular to the first direction; a second electric motor; and a second drive screw driven by the second electric motor, the second drive screw coupled to the first work tool to drive the first work tool in a third direction that is substantially perpendicular to both the first direction and the second direction.

The rapid prototype system of paragraph [0018], wherein the second drive mechanism includes a first electric motor; and a belt driven by the first electric motor, the belt coupled to the first work tool to drive the first work tool in a second direction and a third direction, the second direction and the third direction being substantially perpendicular to each other and the first direction.

The rapid prototype system of paragraph [0020], wherein the third drive mechanism includes a second electric motor; a first drive screw driven by the second electric motor, the first drive screw coupled to the second work tool to drive the second work tool in the second direction; a third electric motor; and a second drive screw driven by the third electric motor, the second drive screw coupled to the second work tool to drive the second work tool in the third direction.

The rapid prototype system of paragraph [0018], wherein the first drive mechanism includes an electric motor; and a drive screw driven by the electric motor.

The rapid prototype system of paragraph [0018], wherein the master unit further includes a platform adapted to support the material, the first drive mechanism driving the platform in the first direction.

The rapid prototype system of paragraph [0018], wherein the plurality of interchangeable modules further includes a third interchangeable module, the at least one component of the third interchangeable module including a light emitting device for emitting light on an object supported by the master unit; and a light receiving device for determining the relative position of the light on the object; wherein the processor is adapted to create a digital three-dimensional image of the object based on the relative position of the light on the object determined by the light receiving device.

The rapid prototype system of paragraph [0018], wherein the plurality of interchangeable modules further includes a third interchangeable module, the at least one component of the third interchangeable module including a polymer curing device, the polymer curing device emitting light on the material, and the material being a photo-curing resin.

The rapid prototype system of paragraph [0018], wherein the master unit further includes an electrical connector coupled to the processor, and the first interchangeable module further includes an electrical component coupled to the at least one component, the electrical component couples to the electrical connector when the first interchangeable module is attached to the master unit, and the electrical component decouples from the electrical connector when the first interchangeable module is detached from the master unit.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a top perspective view of a rapid prototype system according to an embodiment of the present invention;

FIG. 2 is a front view of the rapid prototype system of FIG. 1;

FIG. 3 is a side view of the rapid prototype system of FIG. 1;

FIG. 4 is a front perspective view of the rapid prototype system of FIG. 1 with an interchangeable module detached from a master unit;

FIG. 5 is a front view of the rapid prototype system of FIG. 1 with a support platform in an elevated position;

FIG. 6 is a partial perspective view of the master unit of the rapid prototype system of FIG. 1 illustrating a drive screw coupled to the support platform;

FIG. 7 is a partial perspective view of the master unit of the rapid prototype system of FIG. 1 illustrating an upper housing of the master unit;

FIG. 8 is a partial perspective view of master unit and interchangeable module electrical connection ports of the rapid prototype system of FIG. 1; the remainder of the interchangeable module is hidden for illustrative purposes;

FIG. 9 is a partial perspective view of an interchangeable module of the rapid prototype system of FIG. 1;

FIG. 10 is a bottom perspective view of a first embodiment of an interchangeable module of the rapid prototype system of FIG. 1;

FIG. 11 is a top perspective view of the rapid prototype system of FIG. 1 coupled to a second embodiment of an interchangeable module; an upper wall of the interchangeable module is hidden for illustrative purposes;

FIG. 12 is a bottom perspective view of a third embodiment of an interchangeable module of the rapid prototype system of FIG. 1;

FIG. 13 is a front perspective view of the rapid prototype system of FIG. 1 coupled to a fourth embodiment of an interchangeable module;

FIG. 14 is a front view of a rapid prototype system according to an embodiment of the present invention; and

FIG. 15 is a front view of the rapid prototype system of FIG. 1 illustrating a lid detached from a base.

### DETAILED DESCRIPTION

In some embodiments, the present invention provides a rapid prototype system that includes a master unit (also referred to as a base but need not be positioned on the bottom of the system) and a plurality of detachable and interchangeable modules (also referred to as lids but need not be positioned on the top of the system) that connect with the base physically, electrically, and using software commands. The base includes components that facilitate actions that are performed during many types of rapid prototype methods. For example, the base includes a first drive mechanism (such as a Z-axis drive mechanism) that facilitates raising and/or lowering materials during many types of additive and subtractive rapid prototype methods. Each interchangeable module creates parts or objects according to, for example, one of the rapid prototype methods described herein. Some of the interchangeable modules include specialized components (for example, an FFM module may include second and third drive mechanisms, such as X-axis and Y-axis drive mechanisms) that are unnecessary for some rapid prototype methods (for example, photo-curing polymer projection processes). The master unit is capable of controlling operation of each of the interchangeable modules when connected to the master unit regardless of the specific types of components they include based on module-specific information downloaded from the interchangeable module.

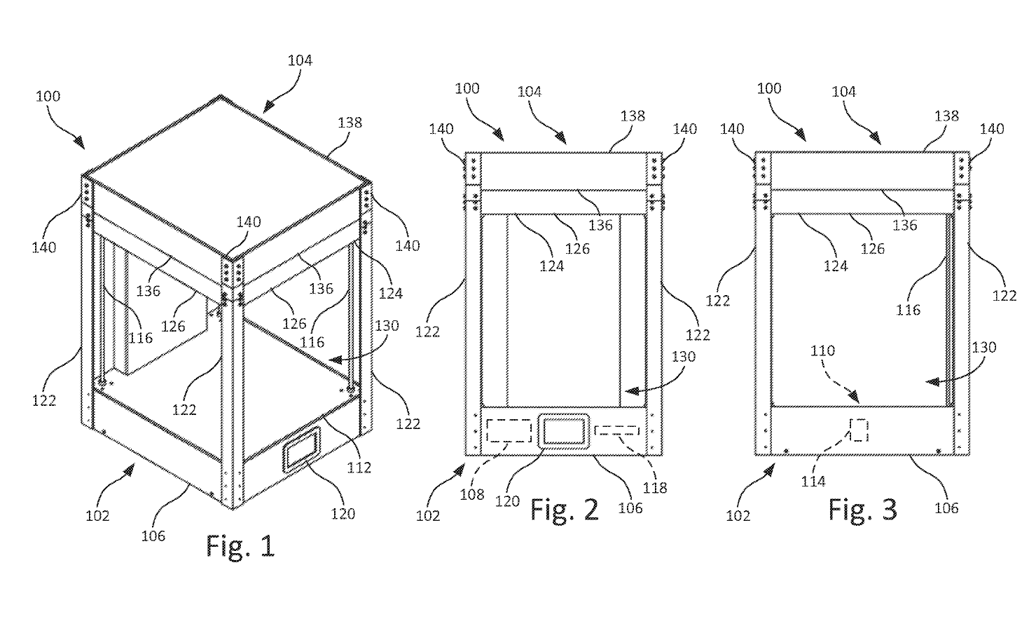

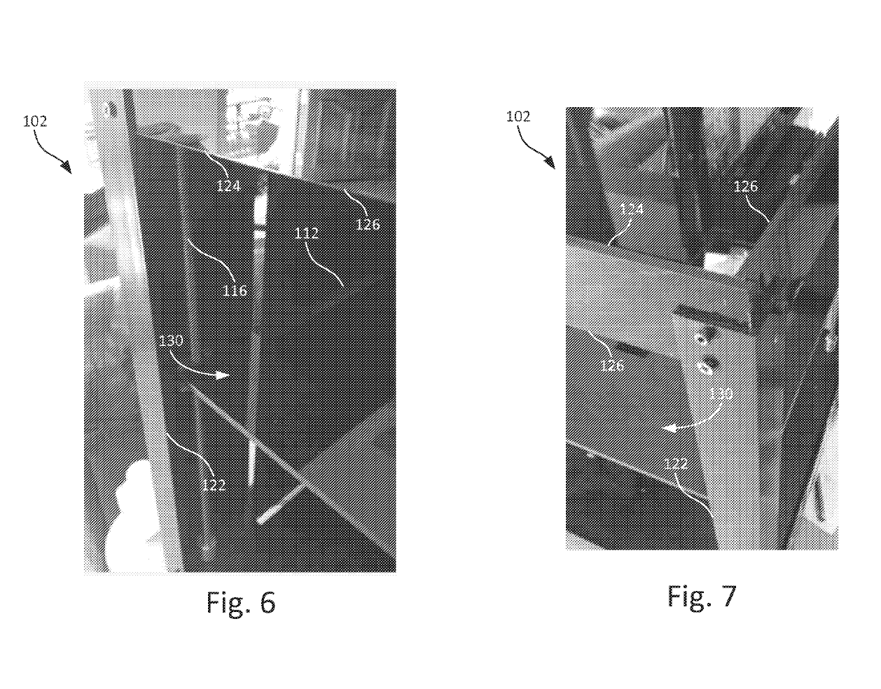

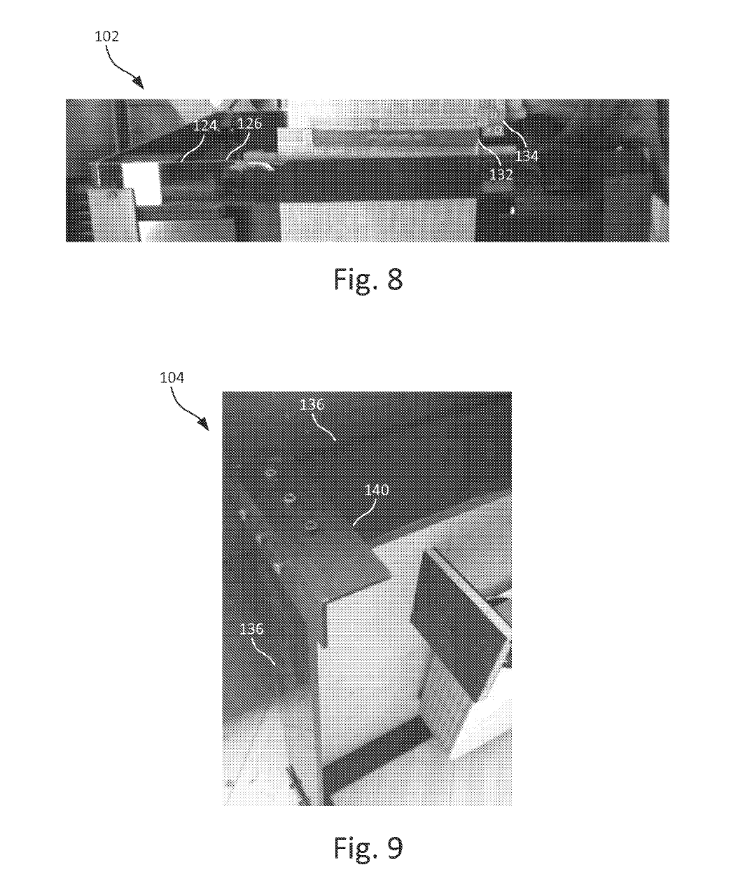

FIGS. 1-8 illustrate a rapid prototype system 100 according to an embodiment of the present invention. The system 100 includes a master unit 102 (also referred to as a “base”, but need not be positioned on the bottom of the system 100) that removably couples to various interchangeable modules 104 (also referred to as “lids” but need not be positioned on the top of the system 100). Each of the interchangeable modules 104 receives commands from the master unit 102 to create parts or objects according to, for example, one of the rapid prototype methods described herein. Such methods include, for example, fused filament fabrication (FFM), sintering, photo-curing polymer, computer numerically controlled (CNC) carving, subsequently developed methods, and the like.

The master unit 102 includes a lower housing 106 that carries various electronic components of the system 100. For example, the lower housing 106 carries a power supply 108 (see FIGS. 2 and 3; for example, components for converting electricity to appropriate currents and voltages, a battery, or the like). The lower housing 106 also carries a drive mechanism 110 (see FIG. 3) that drives an elevating support platform 112 (see FIGS. 1 and 5). That is, the drive mechanism 110 drives the platform 112, and materials supported thereon, in a first direction (for example, a Z-axis direction). In some embodiments, the drive mechanism 110 may include four electric motors 114 (for example, high-torque stepper motors) that each drive a drive screw 116 (see FIGS. 1 and 5) coupled to the support platform 112. In some embodiments, a drive screw 116 may be provided near each of four corners of the lower housing 106. The lower housing 106 also carries a processor 118. As described in further detail below, the processor 118 controls actions of the components of the master unit 102 and a connected interchangeable module 104. Externally, the lower housing 106 carries a user interface 120 (for example, a touch-sensitive display) for receiving inputs from and/or displaying information to a device user.

It should be noted that the master unit 102 lacks specialized components, such as second and third drive mechanisms (for example, X-axis and Y-axis drive mechanisms). Such components could significantly increase the cost of the master unit 102 and add a level of complexity that would sometimes be unnecessary and, in some situations, interfere with the materials supported on the platform 122.

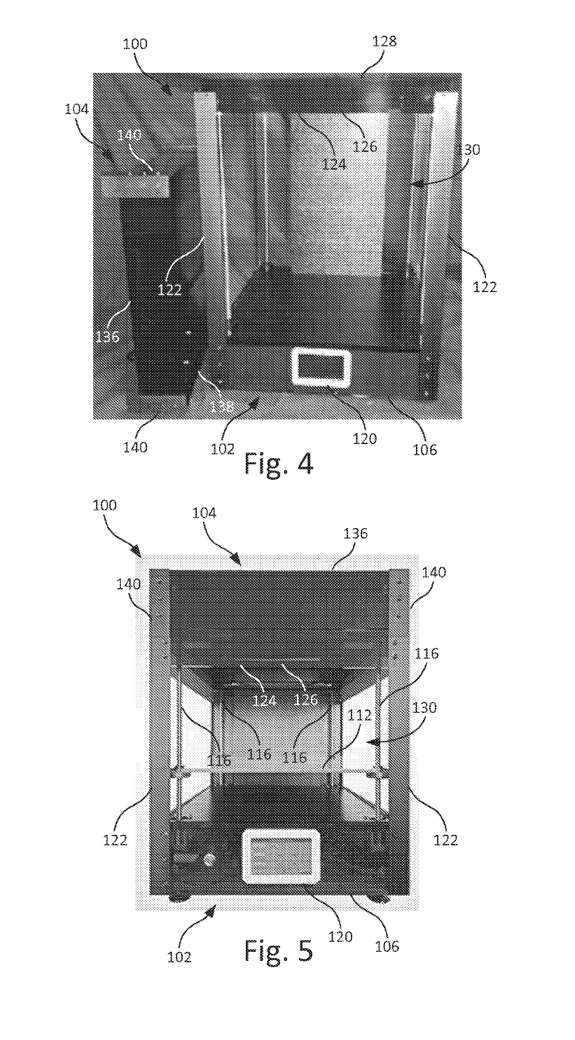

The lower housing 106 also supports posts 122 (for example, angled extruded posts positioned at each of the four corners of the lower housing 106). Opposite the lower housing 106, the posts 122 connect to an upper housing 124. The upper housing 124 includes a plurality of sidewalls 126 that couple the posts 122 to each other. The sidewalls 126 also define an open top side 128 (see FIG. 4) that facilitates attachment of one of the interchangeable modules 104. Together, the upper housing 124, the posts 122, and the lower housing 106 define a work volume 130 in which the system 100 performs rapid prototype methods. In some embodiments, the work volume 130 is about three cubic feet. In some embodiments, the work volume 130 is about one cubic foot.

The upper housing 124 also includes an electrical connector 132 (for example, a multi pin electrical connector) disposed above the sidewalls 126. The electrical connector 132 detachably couples to an electrical component 134 of the interchangeable module 104 coupled to the master unit 102. The master unit 102 transmits power and/or control signals to the interchangeable module 104 via the electrical connection portion 132 and the electrical component 134. This aspect is described in further detail below.

In some embodiments, the upper housing 124, the posts 122, and/or the lower housing 106 may detachably support one or more side panels (not shown) for inhibiting materials from exiting the work volume 130 when the system performs rapid prototype methods. In some embodiments, one or more of the side panels may be transparent or translucent to facilitate user monitoring of the methods performed in the work volume 130.

Referring now to FIGS. 1-5 and 9, each interchangeable module 104 generally includes a plurality of sidewalls 136 and an upper wall 138. The walls 136 and/or 138 support posts 140 (for example, angled extruded posts positioned at each of the four corners of the interchangeable module 104). In some embodiments, the posts 140 extend beyond the sidewalls 136 to detachably couple the interchangeable module 104 to the master unit 102. The walls 136 and/or 138 also support the electrical component 134. In some embodiments, the electrical component 134 of the interchangeable module 104 couples to the electrical connector 132 of the master unit 102 when the interchangeable module 104 is coupled to the master unit 102 via the posts 140, and the electrical component 134 of the interchangeable module 104 decouples from the electrical connector 132 of the master unit 102 when the interchangeable module 104 is detached from the master unit 102.

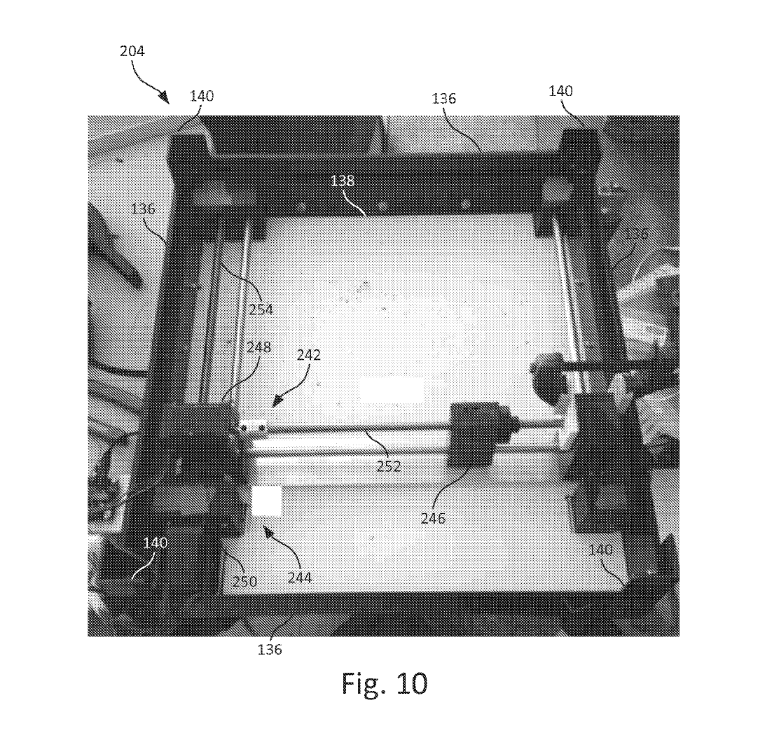

FIG. 10 illustrates a first embodiment of an interchangeable module 204 according to the present invention. The interchangeable module 204 may be detachably coupled from the master unit 102. The interchangeable module 204 may facilitate, for example, CNC carving rapid prototype methods (specifically, creating plastic or wood objects, such as signs or bas-relief products, in hobbyist and/or commercial settings). The interchangeable module 204 includes sidewalls 136, an upper wall 138, and posts 140 as described above. The walls 136 and/or 138 support drive mechanisms 242 and 244 that move a work tool 246 in second and third directions that are substantially perpendicular to each other and the first axis (for example, X-axis and Y-axis directions).

In some embodiments, the drive mechanisms 242 and 244 may include electric motors 248 and 250, respectively, (for example, high-torque stepper motors) that drive screws 252 and 254, respectively, coupled to the work tool 246. In some embodiments, the drive screw 252 may drive the work tool 246 in a second direction that is substantially perpendicular to the first direction (for example, the X-axis direction) and the drive screw 254 may drive the electric motor 248 in a third direction that is substantially perpendicular to both the first direction and the second direction (for example, the Y-axis direction) to thereby drive the work tool 246 in the third direction. The work tool 246 may include, for example, a rotatable cutting tool (not shown). The work tool 246 and the drive mechanisms 242 and 244 receive power and/or control signals from the master unit 102 via the electrical connection portion 132 and the electrical component 134.

In some embodiments, the drive mechanisms 242 and 244 may each include multiple electric motors (not shown) for driving the work tool 246 in the second and third directions (for example, the X-axis and Y-axis directions), respectively. For example, two electric motors (such as high-torque stepper motors) may drive the work tool 246 in the second direction (for example, the X-axis direction), and two electric motors (for example, high-torque stepper motors) may drive the work tool 246 in the third direction (for example, the Y-axis direction). Such embodiments may facilitate more accurate control of the work tool 246 compared to embodiments that include fewer motors; however, such embodiments are also more expensive than embodiments that include fewer motors. A system user may determine which type of these interchangeable modules to purchase by considering the accuracy that is suitable to perform a desired type of rapid prototype method.

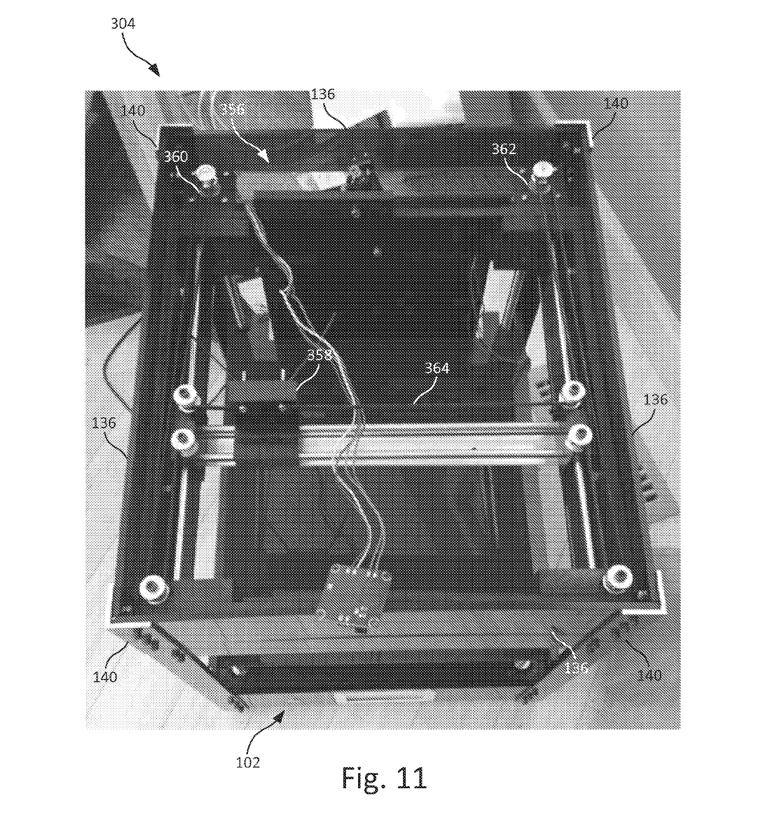

FIG. 11 illustrates a second embodiment of an interchangeable module 304 according to the present invention. The interchangeable module 304 may be detachably coupled from the master unit 102. The interchangeable module 304 may facilitate, for example, FFM rapid prototype methods. The interchangeable module 304 includes sidewalls 136, an upper wall (not shown), and posts 140 as described above. The walls support a drive mechanism 356 that drive a work tool 358 in the second and third directions (for example, the X-axis and Y-axis directions).

In some embodiments, the drive mechanism 356 includes two electric motors 360 and 362 that drive a belt 364 coupled to the work tool 358. The electric motors 360 and 362 drive the work tool 358 in the second and third directions depending on the direction of rotation and rotational speed of the electric motors 360 relative to each other. The work tool 358 may be, for example, a filament dispenser that includes an extrusion head (not shown) and an extrusion motor (not shown) for each color of material delivered by the work tool 358. The work tool 358 and the drive mechanism 356 receive power and/or control signals from the master unit 102 via the electrical connection portion 132 and the electrical component 134.

Embodiments of interchangeable modules that include belt-driven mechanisms, such as the interchangeable module 304, provide less accurate control of work tools compared to modules that include other types of drive mechanisms, such as stepper motor and drive screw-based mechanisms. However, embodiments of interchangeable modules that include belt-driven mechanisms are less expensive than modules that include other types of drive mechanisms. A system user may determine which type of these interchangeable modules to purchase by considering the accuracy that is suitable to perform a desired type of rapid prototype method.

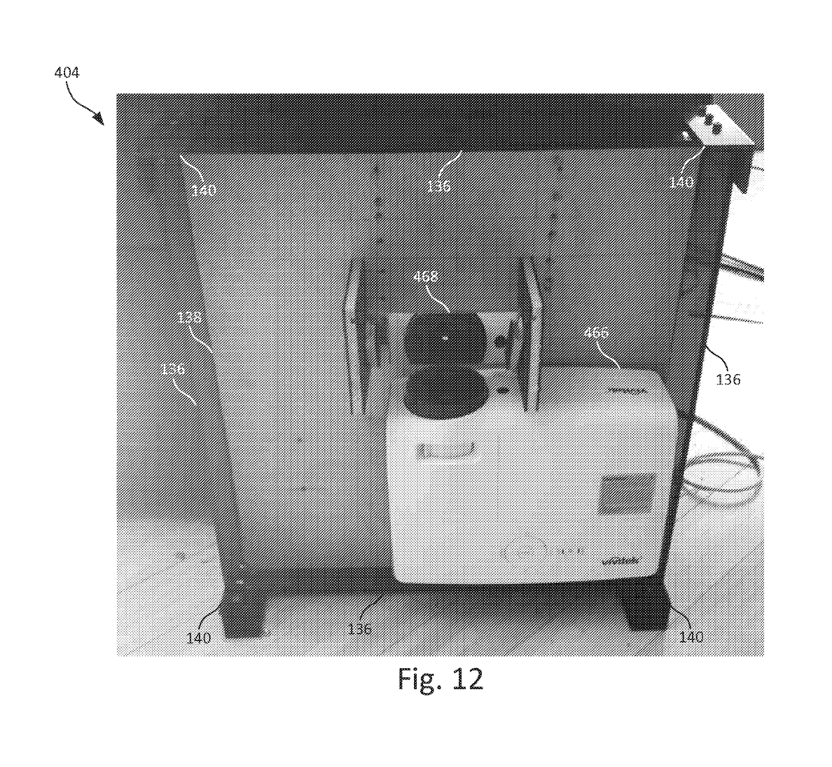

FIG. 12 illustrates a third embodiment of an interchangeable module 404 according to the present invention. The interchangeable module 404 may be detachably coupled from the master unit 102. The interchangeable module 404 may facilitate, for example, photo-curing polymer projection rapid prototype methods. The interchangeable module 404 includes sidewalls 136, an upper wall 138, and posts 140 as described above.

The walls 136 and/or 138 support a polymer curing device 466 (for example, a digital light processing (DLP) projector) that emits a beam of light. A mirror 468 supported by the walls 136 and/or 138 directs the beam of light towards a vat of photo-curing resin (not shown). The vat of photo-curing resin is moved down (for example, using the drive mechanism 110 of the master unit 102) layer-by-layer within the work volume 130.

The polymer curing device 466 and the mirror 468 are fixedly coupled to the walls 136 and/or 138 of the interchangeable module 404. That is, the interchangeable module 404 lacks second and third drive mechanisms (for example, X-axis and Y-axis drive mechanisms) for moving the polymer curing device 466 and the mirror 468. In some embodiments, however, the polymer curing device 466 may be provided as a laser emitting device (not shown) that is driven by one or more of the drive mechanisms (for example, X-axis and Y-axis drive mechanisms) described herein. In some embodiments, the polymer curing device 466 may be provided as a stereo lithography printer (not shown). Such a device uses additional drive mechanisms (for example, X-axis and Y-axis drive mechanisms) to position mirrors and direct light onto a vat of photo-curing polymer.

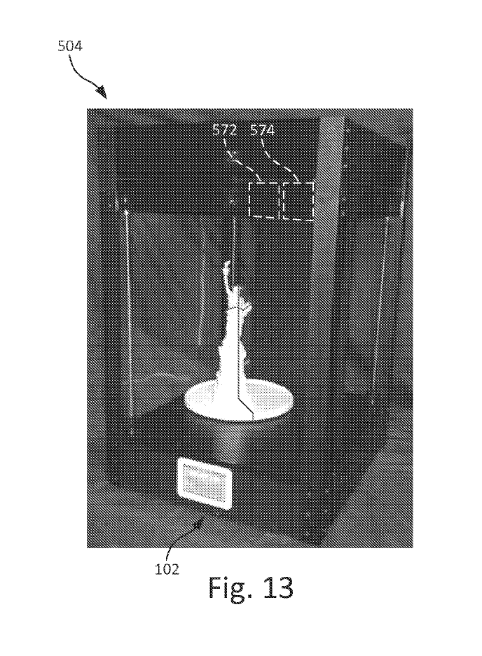

FIG. 13 illustrates a fourth embodiment of an interchangeable module 504 according to the present invention. The interchangeable module 504 may be detachably coupled from the master unit 102. The interchangeable module 504 may facilitate, for example, performing a three-dimensional scan of an object disposed within the work volume 130 of the master unit 102. The scan may provide a digitized image of the object. The digitized image may subsequently be used together with other interchangeable modules described herein or other rapid prototype systems to reproduce the object at various scales and/or using different materials.

The interchangeable module 504 includes a light emitting device 572 (for example, a laser emitting device) and a light receiving device 574 (for example, a digital camera). One or more of the electric motors 114 of the master unit 102 raise and lower the light emitting device 572 and the light receiving device 574. One or more of the remaining electric motors 114 of the master unit 102 rotate the scanned object. The light emitting device 572 projects a line of light on the scanned object, and a light receiving device 574 determines the relative position of the line of light. The edge shape of the scanned object is recorded by the master unit 102, and the master unit 102 rotates the scanned object slightly to allow recording of another edge shape. The master unit 102 uses the edge shapes to create a digital three-dimensional image of the scanned object.

The interchangeable module 504 lacks drive mechanisms (for example, X-axis and Y-axis drive mechanisms) for moving the light emitting device 572 and the light receiving device 574.

Other types of interchangeable modules according to embodiments of the present invention include, but are not limited to:

1. Frosting or edible extrusion;

2. Clay extrusion or laser hardening;

3. Laser sintering;

4. CNC metal carving;

5. Wax deposition for lost wax molds; and

6. Printed circuit board masking and drilling.

The master unit 102 may identify a connected interchangeable module in various manners (that is, identify the type of connected interchangeable module, determine its components, determine its capabilities, or the like). In some embodiments, the processor 118 of the master unit 102 determines the type of interchangeable module coupled thereto and selects a portion of firmware that correctly controls and accurately coordinates actions of the components of the interchangeable module. In some embodiments, each interchangeable module 104 includes a specific configuration of identifier connectors that facilitate identification by the processor 118 of the master unit 102. The processor 118 either recognizes how to control the components of the interchangeable module or indicates that the firmware should be updated. In some embodiments, interchangeable module manufacturers provide the firmware needed to coordinate the activities in the interchangeable module and the master unit 102.

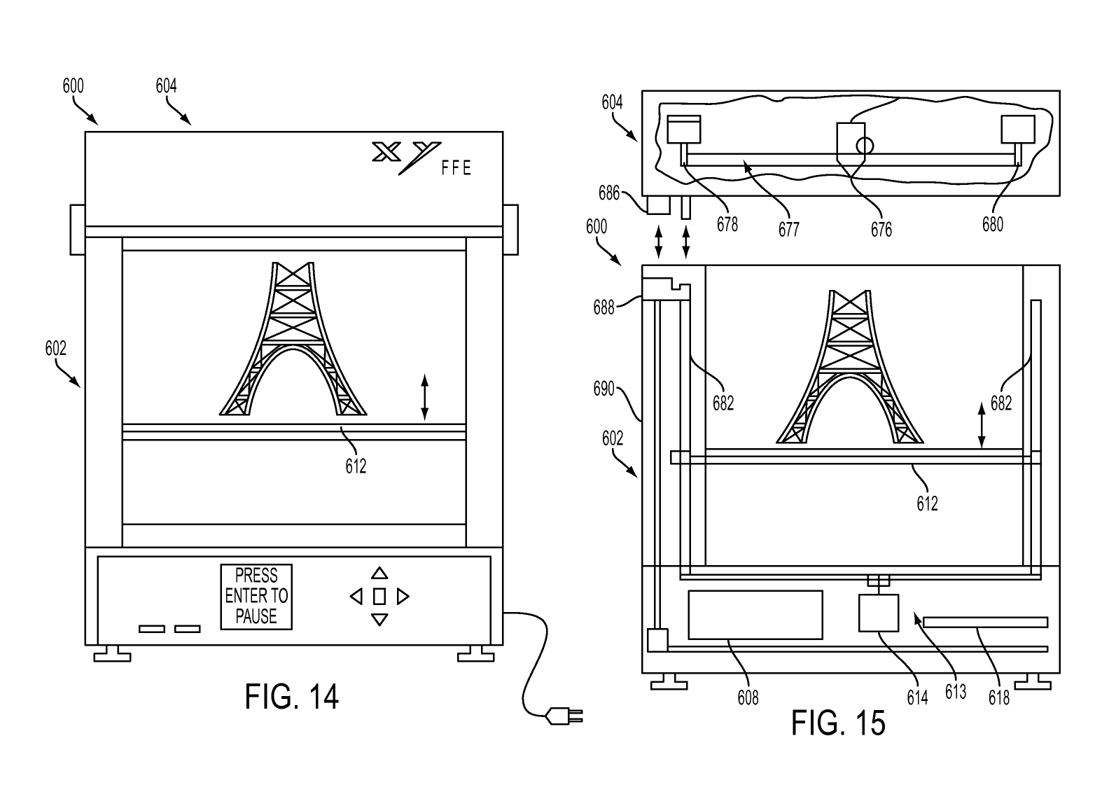

FIGS. 14 and 15 show an exemplary embodiment of a system 600 according to the present invention including a lid 604 that performs a fused filament extrusion process. The base unit 602 includes a drive mechanism 613 that controls the position of the platform 612 (Z-axis) that holds the object to be created in the correct position relative to a filament extruder 676 in the lid 604. In some embodiments, the drive mechanism 613 includes an electric motor 614 (for example, a stepper motor) and one or more transmission elements 682 (for example, drive screws) coupled to the platform 612. The platform 612 moves down one layer at a time as the filament extruder 676 completes the deposition of material (for example, plastic) using a drive mechanism 677 (including, for example, electric motors 678 and 680, such as stepper motors) for controlling motion of the filament extruder 676 in the X-axis and Y-axis directions. The positions of the three axes and deposition of material from the filament extruder 676 are coordinated and powered by a processor 618 of the master unit 602, using a portion of the firmware as instructed by the identification supplied by the interchangeable module 604.

The base 602 further includes a power supply 608 (for example, components for converting electricity to appropriate currents and voltages, a battery, or the like). The lid 604 includes a specific configuration of identifier, power, and control connectors 686 that facilitate identification by the processor 618 of the master unit 602. The base 602 further includes electrical connections 688 and wires 690 that couple the power supply 608, the drive mechanism 613, and the processor 618 to the connectors 686.

In some embodiments, the present invention facilitates one or more of the following advantages: (1) providing a rapid prototype system that is relatively easy to reconfigure; (2) providing cost savings over multiple machines required for different technologies; (3) providing greater cost savings due to economies of scale; (4) providing a standard for development of interchangeable modules with fewer parts; (5) providing an upgrade path for users to diversify gradually; (6) reducing risk of obsolescence and the extension of investment costs.

What is claimed is:

1. A rapid prototype system configured to manipulate material to form an object, the rapid prototype system comprising:
a master unit including:
a housing;
a first drive mechanism coupled to the housing, the first drive mechanism being adapted to displace the material in a first direction;
a processor coupled to the housing, the processor being operably coupled to the first drive mechanism for controlling the first drive mechanism;
a plurality of interchangeable modules being selectively attachable to the master unit, each of the plurality of interchangeable modules including at least one component being operably coupled to the processor of the master unit for controlling the at least one component when the interchangeable module is attached to the master unit, the plurality of interchangeable modules including a first interchangeable module, the at least one component of the first interchangeable module including:
a work tool being adapted to manipulate the material; and
a second drive mechanism coupled to the work tool, the second drive mechanism driving the work tool in a second direction that is substantially perpendicular to the first direction.

2. The rapid prototype system of claim 1, wherein the at least one component of the first interchangeable module further includes a third drive mechanism coupled to the work tool, the third drive mechanism driving the work tool in a third direction that is substantially perpendicular to both of the first direction and the second direction.

3. The rapid prototype system of claim 2, wherein the second drive mechanism includes:
a first electric motor;
a first drive screw driven by the first electric motor, the first drive screw coupled to the work tool to drive the work tool in the second direction;
a second electric motor; and
a second drive screw driven by the second electric motor, the second drive screw coupled to the work tool to drive the work tool in a third direction that is substantially perpendicular to both the first direction and the second direction.

4. The rapid prototype system of claim 1, wherein the second drive mechanism includes:
an electric motor; and
a belt driven by the electric motor, the belt coupled to the work tool to drive the work tool in the second direction and a third direction that is substantially perpendicular to both of the first direction and the second direction.

5. The rapid prototype system of claim 4, wherein the work tool is a filament dispenser being adapted for depositing the material.

6. The rapid prototype system of claim 1, wherein the plurality of interchangeable modules further includes a second interchangeable module, the at least one component of the second interchangeable module including:
a light emitting device for emitting light on an object supported by the master unit; and
a light receiving device for determining the relative position of the light on the object;
wherein the processor is adapted to create a digital three-dimensional image of the object based on the relative position of the light on the object determined by the light receiving device.

7. The rapid prototype system of claim 6, wherein the first drive mechanism drives the light emitting device and the light receiving device in the first direction.

8. The rapid prototype system of claim 1, wherein the plurality of interchangeable modules further includes a second interchangeable module, the at least one component of the second interchangeable module including a polymer curing device, the polymer curing device emitting light on the material, and the material being a photo-curing resin.

9. The rapid prototype system of claim 1, wherein the master unit further includes a platform adapted to support the material, the first drive mechanism driving the platform in the first direction.

10. The rapid prototype system of claim 1, wherein the master unit further includes an electrical connector coupled to the processor, and the first interchangeable module further includes an electrical component coupled to the at least one component, the electrical component couples to the electrical connector when the first interchangeable module is attached to the master unit, and the electrical component decouples from the electrical connector when the first interchangeable module is detached from the master unit.

11. A rapid prototype system configured to manipulate material to form an object, the rapid prototype system comprising:
a master unit including:
a housing;
a first drive mechanism coupled to the housing, the first drive mechanism being adapted to displace the material in a first direction;
a processor coupled to the housing, the processor being operably coupled to the first drive mechanism for controlling the first drive mechanism;
a plurality of interchangeable modules being selectively attachable to the master unit, each of the plurality of interchangeable modules including at least one component being operably coupled to the processor of the master unit for controlling the at least one component when the interchangeable module is attached to the master unit, the plurality of interchangeable modules including:
a first interchangeable module, the at least one component of the first interchangeable module including:
a first work tool being adapted to manipulate the material;
a second drive mechanism coupled to and driving the first work tool;
a second interchangeable module, the at least one component of the second interchangeable module including:
a second work tool being adapted to manipulate the material; and
a third drive mechanism coupled to and driving the second work tool, the third drive mechanism being of a type different than the second drive mechanism.

12. The rapid prototype system of claim 11, wherein the second drive mechanism includes:
a first electric motor;
a first drive screw driven by the first electric motor, the first drive screw coupled to the first work tool to drive the first work tool in a second direction that is substantially perpendicular to the first direction;
a second electric motor; and
a second drive screw driven by the second electric motor, the second drive screw coupled to the first work tool to drive the first work tool in a third direction that is substantially perpendicular to both the first direction and the second direction.

13. The rapid prototype system of claim 11, wherein the second drive mechanism includes:
a first electric motor; and
a belt driven by the first electric motor, the belt coupled to the first work tool to drive the first work tool in a second direction and a third direction, the second direction and the third direction being substantially perpendicular to each other and the first direction.

14. The rapid prototype system of claim 13, wherein the third drive mechanism includes:
a second electric motor;
a first drive screw driven by the second electric motor, the first drive screw coupled to the second work tool to drive the second work tool in the second direction;
a third electric motor; and
a second drive screw driven by the third electric motor, the second drive screw coupled to the second work tool to drive the second work tool in the third direction.

15. The rapid prototype system of claim 11, wherein the first drive mechanism includes:
an electric motor; and
a drive screw driven by the electric motor.

16. The rapid prototype system of claim 11, wherein the master unit further includes a platform adapted to support the material, the first drive mechanism driving the platform in the first direction.

17. The rapid prototype system of claim 11, wherein the plurality of interchangeable modules further includes a third interchangeable module, the at least one component of the third interchangeable module including:
a light emitting device for emitting light on an object supported by the master unit; and
a light receiving device for determining the relative position of the light on the object;
wherein the processor is adapted to create a digital three-dimensional image of the object based on the relative position of the light on the object determined by the light receiving device.

18. The rapid prototype system of claim 11, wherein the plurality of interchangeable modules further includes a third interchangeable module, the at least one component of the third interchangeable module including a polymer curing device, the polymer curing device emitting light on the material, and the material being a photo-curing resin.

19. The rapid prototype system of claim 11, wherein the master unit further includes an electrical connector coupled to the processor, and the first interchangeable module further includes an electrical component coupled to the at least one component, the electrical component couples to the electrical connector when the first interchangeable module is attached to the master unit, and the electrical component decouples from the electrical connector when the first interchangeable module is detached from the master unit.
